(19) United States
(12) Patent Application Publication
(10) Pub. No.: US 2007/0189228 A1
(43) Pub. Date: Aug. 16, 2007

(54) Method for establishing an atm traffic channel path between a bsc and a bts in an ev-do system

(75) Inventor: Woo Seog Koo, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/560,142

(22) PCT Filed: Jul. 23, 2004
(86) PCT No.: PCT/KR04/01856

§ 371 Date: Nov. 2, 2006

(30) Foreign Application Priority Data
Jul. 24, 2003 (KR) 10-2003-0051157

(51) Int. Cl. H04B 7/216

(52) U.S. Cl. 370/335

(57) ABSTRACT

The present invention generally relates to a method for establishing an asynchronous transfer mode (ATM) traffic channel path between a SF block of a base station controller (BSC) and a channel card block (HCCA) of a base transceiver station (BTS). More particularly, the present invention is directed to a method for establishing an ATM traffic channel path between the SF block of the BSC and the channel card block of the BTS and exchanging information on such established path necessary for establishing such path, wherein the blocks have been designed and implemented in the course of commercializing ATM communication network based on an evolution-data only (EV-DO) system of Qualcomm. The present invention modifies a conventional message between the BSC and BTS, conceives a new message between them while reflecting the conventional message and provides an additional way of exchanging information on the ATM path. In this way, the present invention can be used for establishing the ATM path between the BSC and BTS in the telecommunication network based on the ATM. In summary, the present invention provides a method of establishing the ATM traffic channel path between the BSC and the BTS in the EV-DO system, which requires minimal changes to the system when a network basis is changed from the IP to the ATM.

### TECHNICAL FIELD

The present invention generally relates to a method for establishing an asynchronous transfer mode (ATM) traffic channel path between a SF block of a base station controller (BSC) and a channel card block (HCCA) of a base transceiver station (BTS). More particularly, the present invention is directed to a method for establishing an ATM traffic channel path between the SF block of the BSC and the channel card block of the BTS and exchanging information on such established path necessary for establishing such path, wherein the blocks have been designed and implemented in the course of commercializing ATM communication network based on an evolution-data only (EV-DO) system of Qualcomm.

### BACKGROUND ART

Generally, the early products of Qualcomm for the EV-DO system were designed for and implemented on an Internet protocol (IP) communication network.

However, when the communication services needed to be processed on other types of communication protocol interfaces (especially an ATM interface), it appeared that every element of the early products needed to be newly developed and redesigned.

Therefore, there is a need in the art for flexibility and compatibility to adapt to various changes in the communication protocol.

### DISCLOSURE OF INVENTION

### Technical Solution

In order to address and resolve the above-mentioned deficiency of prior art products, the present invention is created based on the following basic principle: an ATM path is dynamically allocated after exchanging information on the ATM path. In order to implement such a principle, the present invention modifies a conventional message between the BSC and BTS, conceives a new message between them while reflecting the conventional message, and provides an additional way of exchanging information on the ATM path. In this way, the present invention can be used for establishing the ATM path between the BSC and BTS in the telecommunication network based on the ATM. In summary, the present invention provides a method of establishing the ATM traffic channel path between the BSC and BTS in the EV-DO system, which requires minimal changes to the system when a network basis is changed from the IP to the ATM.

According to the present invention, a method for establishing an ATM traffic path between a BSC and a BTS in an EV-DO system comprises the following steps:

requesting traffic channel allocation from a SF block to a channel card block when information on an ATM path of the BTS is extracted and the ATM path is fixed in the channel card block;

requesting setup of an ATM switch block to an OHM block when a response to the request for the traffic channel allocation is received;
establishing a transmission message between the OHM block and the ATM switch block, and modifying an OHM database when the setup is accepted;

at the SF block, calling an ATM path extraction function and an ATM path establishing function based on channel card information when taskSpawn SFBlink is executed at the OHM block after the database is modified; and

at the OHM block, transmitting a response to the request for the ATM switch block setup when the ATM path extraction function and the ATM path establishing function are called.

### ADVANTAGEOUS EFFECTS

The present invention is used for establishing an ATM path between a BSC and a BTS in a communication network based on ATM. The present invention is advantageous in that only minimum changes to the message are required for converting a telecommunication basis from IP to ATM.

### BRIEF DESCRIPTION OF THE DRAWINGS

These drawings depict only the preferred embodiments of the present invention and should not be considered as limitations of its scope. These as well as other features of the present invention will become more apparent upon reference to the drawings in which:

FIG. 1 illustrates a SF of the BSC and a channel card block of the BTS, as well as interactive operations between other entities in accordance with the present invention; and

FIG. 2 illustrates a diagram for processing a call message to establish an ATM path in accordance with the present invention.

### BEST MODE FOR CARRYING OUT THE INVENTION

In the following detailed description, the preferred embodiment of the present method for establishing an ATM traffic channel path between the BSC and the BTS in the EV-DO system will be described in view of the accompanying drawings.

First, the present invention utilizes and resorts to the technical concept of modifying the conventional message between the BSC and BTS, and conceiving a new message between them in order to provide an additional way of exchanging information on a corresponding ATM path. In order words, when the SF block of the BSC requires information on an ATM path of a channel card to set up the channel card of the BTS to thereby establish the ATM path, the present invention maintains the conventional message as much as possible. At the same time, it creates a new message so as to exchange information on the ATM path and subsequently perform dynamic allocation of the ATM path.

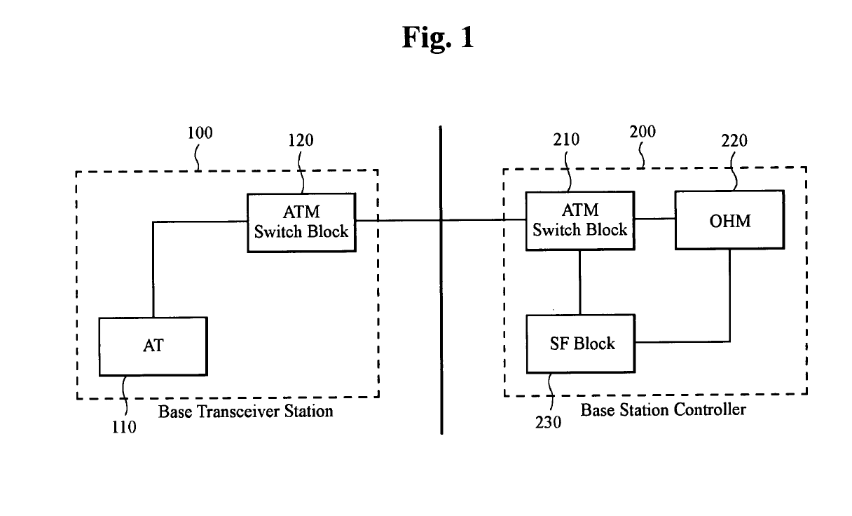

FIG. 1 shows the interactive operations between the SF of BSC, the channel card block of the BTC and the other entities in accordance with the present invention.

Referring to FIG. 1 which illustrates the entire system structure of the present invention, the SF block 230 of EV-DO system is placed in the BSC 200 and the channel card block 120 is placed in the BTS 100. The channel card block 120 plays a relay role between an access terminal (AT) 110 and the SF block 230.

In the entire structure, it is necessary to establish an ATM path for both the BSC and BTS. Among the above two establishments, the present invention is directed to establishing an ATM path for the BSC.

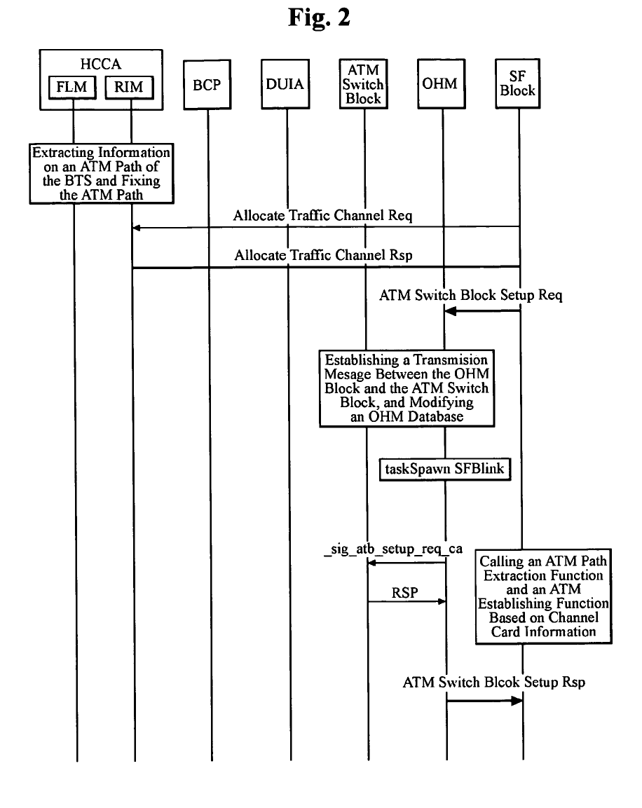

FIG. 2 is a diagram illustrating a process for managing a call message in order to establish an ATM path in accordance with the present invention.

As illustrated in FIG. 2, the method of the present invention comprises the following steps: requesting traffic channel allocation from a SF block to a channel card block when information on an ATM path of the BTS is extracted and the ATM path is fixed in the channel card block, requesting setup of an ATM switch block to an OHM block when a response to the request for the traffic channel allocation is received; establishing a transmission message between the OHM block and the ATM switch block, and modifying an OHM database when the setup is accepted; at the SF block, calling an ATM path extraction function and an ATM path establishing function based on channel card information when taskSpawn SFBlink is executed at the OHM block after the database is modified; and at the OHM block, transmitting a response to the request for the ATM switch block setup when the ATM path extraction function and the ATM path establishing function are called.

The method of the present invention relates to a flow of messages between SF's software blocks, and more particularly to processing messages for establishing an ATM path in the course of managing a call set-up message received from a terminal.

In the following description, the foregoing messages between the blocks will be discussed in view of the tables provided below.

First, AllocateTrafficChannelRsp message is a modified version of a conventional version and is transmitted from the BTS (i.e., the channel block) to the BSC (i.e., the SF block). The table below shows the particular details of AllocateTrafficChannelRsp message.

TABLE 1

| Type | Attribute | Value |
|---|---|---|
| word16 | RsmId | 0˜7 |
| byte | BcpId | 0˜64 |
| byte | SectorId | 0˜2 |
| byte | FtcCcId | 0˜1 |
| byte | FtcCeId | 0˜64 |
| byte | FtcBaiaId | 0˜1 |
| byte | FtcBlinkId | 0˜7 |
| byte | FtcSfPortId | 0˜2 |
| byte | RxcCcId | 0˜1 |
| byte | RxcCeId | 0˜64 |
| byte | RxcBaiaId | 0˜1 |
| byte | RxcBlinkId | 0˜7 |
| byte | RxcSfPortId | 0˜2 |

Next, ASBSetupReq message is newly conceived and is transmitted from the BSC (i.e., the SF block) to the BSC (i.e., the OHM block). The table below shows the details of ASBSetupReq message.

TABLE 2

| Type | Attribute | Value |
|---|---|---|
| word16 | RsmId | 0˜7 |
| byte | Result | 0: Fail, 1: Succes |
| word16 | FtcSfToAtbVpi | 0˜152 |
| word16 | FtcSfToAtbVci | 0˜1024 |
| word16 | RxcSfToAtbVpi | 0˜512 |
| word16 | RxcSfToAtbVci | 0˜1024 |

Additionally, ASBSetupRsp message is newly created and is transmitted from the BSC (i.e., the SF block) to the BSC (i.e., the OHM block). The table below shows the details of ASBSetupReq message.

TABLE 3

| | Attribute | Value |
|---|---|---|
| Type | | |
| word16 | functionId | 2501 |
| word32 | callId | |
| word16 | RSMId | 0˜7 |
| word16 | pilotOffset | |
| byte | status | |
| byte | powerControlBitNumber | |
| word32 | FLMIPAddress | |
| word16 | ftcServerPort | |
| word32 | RLMIPAddress | |
| word16 | rxcServerPort | |
| Additional Entry | | |
| byte | bcpId | 0˜64 |
| byte | btsSectorIdx | 0˜2 |
| byte | ftc_ccId | 0˜1 |
| byte | ftc_ceId | 0˜64 |
| byte | ftcBaiaId | 0˜1 |
| byte | ftc_LinkId | 0˜7 |
| byte | rxc_ccId | 0˜1 |
| byte | rxc_ceId | 0˜64 |
| byte | rxcBaiaId | 0˜1 |
| byte | rxcLinkId | 0˜7 |

The foregoing description of the preferred embodiment is provided to clearly explain a method for establishing an ATM traffic path between a BSC and a BTS in an EV-DO system. However, various modifications to the embodiment could be made within the scope of the present invention. Thus, the present invention should not be limited to the embodiment described in the foregoing, but should have the scope consistent with the appended claims and their equivalents.

### INDUSTRIAL APPLICABILITY

In accordance with the present invention, a method for establishing an ATM traffic path between a BSC and a BTS in an EV-DO system is used for establishing an ATM path between a BSC and BTS in a communication network based on ATM. The present method is advantageous in that only minimum changes to the message are required in converting a telecommunication basis from IP to ATM. In order to achieve such a goal, the present invention maintains the conventional message as much as possible. At the same time, it creates the new message in order to exchange information on the ATM path and subsequently perform dynamic allocation of the ATM path.

1. A method for establishing an ATM traffic path between a BSC and a BTS in an EV-DO system, the method comprising the steps of:
requesting traffic channel allocation from a SF block to a channel card block when information on an ATM path of the BTS is extracted and the ATM path is fixed in the channel card block;
requesting setup of an ATM switch block to an OHM block when a response to the request for the traffic channel allocation is received;
establishing a transmission message between the OHM block and the ATM switch block, and modifying an OHM database when the setup is accepted;
at the SF block, calling an ATM path extraction function and an ATM path establishing function based on channel card information when taskSpawn SFBlink is executed at the OHM block after the database is modified; and
at the OHM block, transmitting a response to the request for the ATM switch block setup when the ATM path extraction function and the ATM path establishing function are called.
